(19) United States
(12) Patent Application Publication
(10) Pub. No.: US 2022/0066975 A1
(43) Pub. Date: Mar. 3, 2022

(54) BIT STREAM TRANSFORMATION IN PARALLEL DATA INTERFACES

(71) Applicant: TEXAS INSTRUMENTS INCORPORATED, Dallas, TX (US)

(72) Inventors: Aravind GANESAN, Bengaluru (IN); Nagalinga Swamy Basayya AREMALLAPUR, Ranebennur (IN); Jaiganesh BALAKRISHNAN, Bengaluru (IN); Robert Clair KELLER, Freidrichshafen (DE)

(21) Appl. No.: 17/364,672

(22) Filed: Jun. 30, 2021

(30) Foreign Application Priority Data
Sep. 1, 2020 (IN) 202041037614

(51) Int. Cl. G06F 13/42; G06F 13/16; G06F 1/12

(52) U.S. Cl. CPC G06F 13/4282; G06F 1/12; G06F 13/1615

(57) ABSTRACT

A circuit includes: a parallel data interface; and transition control circuitry coupled to the parallel data interface. The transition control circuitry is configured to: receive an input bit stream sample; determine a bit transformation pattern for the input bit stream sample in accordance with a target criteria; and generate an output bit stream symbol from the input bit stream sample and the bit transformation pattern, wherein the output bit stream symbol has more bits than the input bit stream sample.

### CROSS-REFERENCE TO RELATED APPLICATIONS

This application claims priority to India Provisional Application No. 202041037614, filed Sep. 1, 2020, which is hereby incorporated by reference.

### BACKGROUND

As new electronic devices are developed and integrated circuit (IC) technology advances, new IC products are commercialized. One example IC product for electronic devices includes one or more circuits configured to communicate via a parallel data interface. The parallel data interface of the IC may be used for communications between different circuits or chiplets of the IC, or between different ICs (chips). Issues resulting from parallel data interfaces include: power supply ripple may be introduced to sensitive sub-systems of an IC due to transitions on the related parallel data interface lanes; power consumption of the IC increases as the number of transitions on the parallel data interface lanes increases; and simultaneous switching related to transitions on the parallel data interface lanes negatively impact output driver performance.

An example IC with a parallel data interface includes a radio frequency (RF) sampling transceiver with an analog front-end (AFE) or other components that are sensitive to power supply ripple. In one example, the parallel data interface couples the AFE to a baseband processor such as a field-programmable gate array (FPGA) or application-specific IC (ASIC). In this example, the parallel data interface transfers complex baseband I/Q samples between the AFE and the baseband processor by mapping the samples to a parallel bit stream (e.g., as 16-bit input words or symbols) and transferring the mapped input words through the parallel data interface lanes. As an example, the parallel data interface may convert 1 gigasample per second (Gsps) of I/Q samples (e.g., each sample corresponding to a 16 bit symbol or other multi-bit symbol) to a 16-bit parallel stream at 2 gigabits per second (GBPS). In this scenario, the AFE is sensitive to power supply ripple caused by data dependent transitions in complementary metal oxide semiconductor (CMOS) switches for the parallel data interface lanes. Also, the power consumption of the parallel data interface increases with the toggle factor (i.e., the average number of transitions).

One conventional approach to reducing power supply ripple uses differential traces, instead of single-ended traces, for each of the parallel data interface lanes. This would partly mitigate the power supply ripple because a transition (e.g., from the power supply voltage (VDD) to ground) in one trace of a differential pair is accompanied by an opposite transition in another trace. However, differential traces double the number of traces required (e.g., 512 lanes instead of 256 lanes for 8 receiver channels), and is not practical given the large number of parallel interface lanes to be supported. Another conventional approach introduces extra logic to perform dummy transitions (e.g., from ground to VDD) at each clock edge, which cancels the switching activity in each of the interface lanes. However, this dummy transition technique may not sufficiently mitigate the power supply ripple because the dummy transitions provided by the extra logic will not be propagated to the ports and the trace load would not be matched. Also, the dummy transition technique increases power consumption.

### SUMMARY

In one example embodiment, a circuit comprises: a parallel data interface; and transition control circuitry coupled to the parallel data interface. The transition control circuitry is configured to: receive an input bit stream sample; determine a bit transformation pattern for the input bit stream sample in accordance with a target criteria; and generate an output bit stream symbol from the input bit stream sample and the bit transformation pattern, wherein the output bit stream symbol has more bits than the input bit stream sample.

In another example embodiment, a system comprises: a first electronic circuit; and parallel data interface lanes coupled to the first electronic circuit and adapted to be coupled to a second electronic circuit. The first electronic circuit is configured to: receive an input bit stream sample; determine a bit transformation pattern for the input bit stream sample in accordance with a target criteria; generate an output bit stream symbol from the input bit stream sample and the bit transformation pattern, wherein the output bit stream symbol has more bits than the input bit stream sample; and provide the output bit stream symbol to the parallel data interface lanes.

In yet another embodiment, a method comprises: receiving an input bit stream sample; determining a bit transformation pattern for the input bit stream sample in accordance with a target criteria; generating an output bit stream symbol from the input bit stream sample and the bit transformation pattern, wherein the output bit stream symbol has more bits than the input bit stream sample; and providing the output bit stream symbol to parallel data interface lanes.

### BRIEF DESCRIPTION OF THE DRAWINGS

FIG. 1 is a block diagram of a system in accordance with an example embodiment.

FIG. 2 is a graph of bit transition distribution as a function of relative frequency for a parallel data interface in accordance with a conventional technique.

FIG. 3 is a block diagram of a system in accordance with an example embodiment.

FIG. 4 is a block diagram of a transmitter with transition control circuitry in accordance with an example embodiment.

FIG. 5 is a block diagram of a bit stream transformer in accordance with an example embodiment.

FIG. 6 is a block diagram of a transition optimizer in accordance with an example embodiment.

FIG. 7 is a block diagram of an inverse bit stream transformer in accordance with an example embodiment.

FIG. 8 is a block diagram of a receiver in accordance with an example embodiment.

FIG. 9 is a graph of bit transition distribution as a function of relative frequency comparing raw bit transitions and coded bit transitions due to a bit stream transformer in accordance with an example embodiment.

FIG. 10 is a table of bit transformation patterns in accordance with an example embodiment.

FIG. 11 is a graph of bit transition distribution as a function of relative frequency comparing raw bit transitions and coded bit transitions due to a bit stream transformer in accordance with another example embodiment.

FIGS. 12A and 12B are block diagrams of transmitters with parallelized implementations of transition control circuitry in accordance with example embodiments.

FIG. 13 is a block diagram of a serialized implementation of transition control circuitry in accordance with an example embodiment.

FIG. 14 is a block diagram of another parallelized implementation of transition control circuitry in accordance with an example embodiment.

FIG. 15 is a block diagram of a modified transition optimizer in accordance with an example embodiment.

FIG. 16 is a block diagram of transition control circuitry in accordance with another example embodiment.

FIG. 17 is a flowchart of a bit transition control method in accordance with an example embodiment.

FIG. 18 is a table of bit transformation patterns in accordance with another example embodiment.

FIG. 19 is a table of bit transformation patterns in accordance with yet another example embodiment.

FIG. 20 is a graph of a spectrum of bit stream switching (magnitude as a function of frequency) comparing raw bits and transformed bits due to transition control circuitry for a parallel data interface in accordance with an example embodiment.

FIG. 21 is a graph of a spectrum of bit stream switching (magnitude as a function of frequency) comparing raw bits and transformed bits due to transition control circuitry for a parallel data interface in accordance with an example embodiment.

The same reference numbers (or other reference designators) are used in the drawings to designate the same or similar (structurally and/or functionally) features.

### DETAILED DESCRIPTION

Some example embodiments include transition control circuitry for use with a parallel data interface between electronic circuits (e.g., integrated circuits (ICs), chiplets, multi-chip modules (MCMs), system-on-a-chips (SoCs), circuitry on a printed circuit board (PCB), combinations thereof, etc.). The transition control circuitry is configured to mitigate undesirable power supply ripple and/or power consumption due to bit transitions (changing a bit value from “0” to “1”, or from “1” to “0”) on the parallel data interface. More specifically, power supply ripple is due to variance in the number of bit transitions for each output symbol transmitted via the parallel data interface. Meanwhile, power consumption increases as the total number of bit transitions for all output symbols transmitted by the parallel data interface increases. In one example embodiment, a parallel data interface and transition control circuitry is used for communications between a first electronic circuit and a second electronic circuit. In different example embodiments, the first and second electronic circuits vary. Example first and/or second electronic circuits include baseband processors, field-programmable gate arrays (FPGAs), application-specific ICs (ASICs), memories, data samplers, transceivers, peripherals, analog-to-digital converters (ADCs), digital-to-analog converters (DACs), analog front-ends (AFEs), and/or other circuits with a parallel data interface.

In one example embodiment, the transition control circuitry is configured to reduce bit transition variance on the parallel data interface to mitigate power supply ripple to components of the first and/or second electronic circuits relative to an electronic circuit having a parallel data interface without the transition control circuitry. In other example embodiments, the transition control circuitry is configured to reduce the total number of bit transitions on the parallel data interface to reduce power consumption of the first and/or second electronic circuits relative to an electronic circuit without the transition control circuitry.

In some example embodiments, the transition control circuitry uses a few extra parallel data interface lanes (e.g., n-k extra interface lanes) to transfer k-bit words as n-bit symbols, where k is a first integer and n is a second integer larger than k. In one example n=20, k=16, where n parallel data interface lanes are used to transmit the k-bit words using n-bit symbols. In this example, there are 4 (n-k) extra parallel data interface lanes, which gives the transition control circuitry flexibility to optimize bit transitions on the parallel data interface to: reduce bit transition variance on the parallel data interface lanes; or reduce the total number of bit transitions on the parallel data interface lanes.

In some example embodiments, the transition control circuitry includes: a bit stream transformer configured to map the k-bit input words into n-bit output symbols; and a transition optimizer configured to select an optimal bit transformation pattern in accordance with a target criteria (e.g., reduce bit transition variance and/or reduce the total number of bit transitions). In one example embodiment, the optimal bit transformation pattern is based on a previously transferred n-bit output symbol and a current k-bit input word. On the receiver side, complementary transition control circuitry (relative to the transmitter side circuitry) receives the n-bit symbols and uses an inverse bit stream transformer to recover each k-bit input word.

In some example embodiments, the transition optimizer determines the bit transformation pattern based on a figure of merit approach. As used herein, “figure of merit” refers to comparing the performance of multiple options relative to a target criteria (e.g., a minimum variance in the number of bit transitions for output symbols resulting from application of bit transformation patterns, or a minimum number of total bit transitions for output symbols resulting from application of bit transformation patterns), and selecting the option with the best performance. In one example, the figure of merit uses a target criteria that minimizes the total number of bit transitions for the parallel data interface. In another examples, the figures of merit uses a target criteria that minimizes bit transition variance (targeting the same number of transitions for each of the n-bit output symbols).

In some example embodiments, the transition control circuitry prepares output symbols for parallel data transfers between first and second electronic circuits with one or more the following design targets: minimize the number of bit transitions on the parallel data interface to reduce power consumption; maintain the number of bit transitions on the parallel data interface constant (reduce the standard deviation of bit transitions) to reduce power supply ripple; coding and decoding complexity should be reasonable; and support error detection if possible (e.g., mark errors in the data stream). By maintaining the number of bit transitions constant (or reducing bit transition variance), the transition control circuitry reduces coupling of power supply ripple by reducing the variance of switching activity (e.g., the switching activity of high current complementary metal oxide semiconductor (CMOS) switches due to transitions) to analog sub-systems and/or other sensitive sub-systems of an IC. Other benefits of the transition control circuitry may include: better analog performance in terms of signal-to-noise ratio (SNR) and spurious noise reduction; reduced power supply interference; and reduced simultaneous switching noise (SSN).

The described transition control circuitry options and related operations are able to reduce the variance in the number of bit transitions on the parallel data interface for each of the n-bit output symbols at the expense of some extra lanes. With the transition control circuitry, there can be a tradeoff between reducing variance in the number of bit transitions and reducing the total number of transitions (i.e., reduce noisy interference or power supply ripple at the expense of increased power consumption). In some example embodiments, an additional parity bit on the parallel data interface is used with the transition control circuitry to reduce the chances of undetected data corruption. Also, different versions of the described encoding algorithm can be developed using different transformation patterns (sometimes called “masks” herein) and/or selection criteria for bit transition targets at the transmitter. Regardless of the particular encoding algorithm used, the receiver implementation is simple and involves only an unmasking operation to recover the original input words.

In the figures, blocks are sometimes used to describe circuits, components, or related operations. In different embodiments, these blocks could be combined or further divided without changing the intended functionality described. Without limitation, such blocks may represent hardware, firmware, and/or software. In some example embodiments, the blocks represent instructions stored in memory and executable by a processor to perform the functionality described. As desired, it is possible to implement described operations using different combinations of logic, hardware, firmware, and/or software.

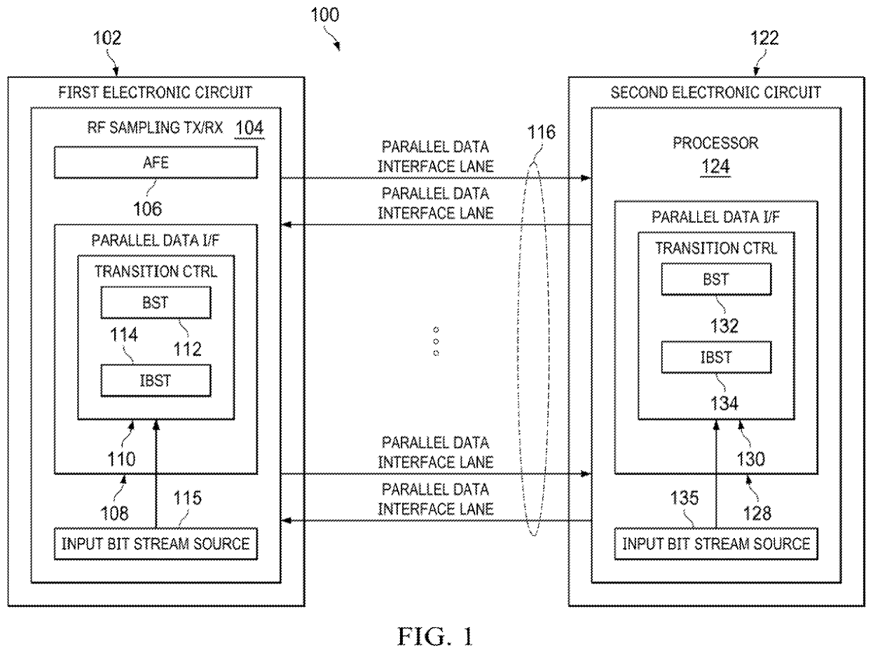

FIG. 1 is a block diagram of a system 100 in accordance with an example embodiment. As shown, the system 100 includes a first electronic circuit 102 (e.g., an IC, a chiplet, an MCM, an SoC, or circuitry on a PCB) in communication with a second electronic device (e.g., an IC, a chiplet, an MCM, an SoC, or circuitry on a PCB). In the example of FIG. 1, the first electronic circuit 102 includes an RF sampling transceiver 104. In other example embodiments, the first circuit includes a baseband processor, FPGA, ASIC, memory, data sampler, ADC, DAC, peripheral, AFE and/or other circuit with a parallel data interface.

The RF sampling transceiver 104 includes an AFE 106 and a parallel data interface 108. The parallel data interface 108 includes hardware, firmware, and/or software configured to: prepare input data for transmission via parallel data interface lanes 116; and/or recover data from symbols received from the parallel data interface lanes 116. The RF sampling transceiver 104 also includes an input bit stream source 115 coupled to the parallel data interface 108 and configured to provide an input bit stream or related samples to the transition control circuitry 110 of the parallel data interface 108. Without limitation to other example embodiments, the input bit stream source 115 may provide complex baseband I/Q samples from the AFE 106 to the transition control circuitry 110 for transfer to a second electronic circuit (e.g., a baseband processor). In different example embodiments, the input bit stream source 115 may be a serial communication interface or parallel communication interface between the AFE 106 and the parallel data interface 108. In some example embodiments, the first electronic circuit 102 is in communication with one or more wireless transceivers (not shown), which provide data to the RF sampling transceiver 104 as analog signals. The RF sampling transceiver 104 converts received analog signals to digital form, resulting in an input bit stream being buffered, stored, and/or otherwise provided to the transition control circuitry 110 by the input bit stream source 115. As described herein, samples of the input bit stream are converted to output symbols, in accordance with a bit transformation pattern, and are transferred to the second electronic circuit 122 via the parallel data interface lanes 116.

The second electronic circuit 122 is configured to recover the input bit stream samples from the output symbols. The recovered input bit stream samples are combined as appropriate and then processed, analyzed, stored, and/or forwarded by the second electronic circuit 122. In different example embodiments, the second electronic circuit 122 may generate input bit streams (related to and/or unrelated to a recovered input bit stream) for transmission to the first electronic circuit 122 via the parallel data interface 128 and the parallel data interface lanes 116. The first electronic circuit 102 is configured to recover input bit streams from the second electronic circuit 122, prepare the recovered input bit streams for wireless transmission as appropriate, and transmit the input bit streams as analog signals to other wireless transceivers. In other example embodiments, the first electronic device 102 and the second electronic device 122 vary from the RF transceiver and baseband processor example given.

The parallel data interface 108 is coupled to or includes transition control circuitry 110, which operates to: mitigate power supply ripple due to variance in the number of bit transitions on the parallel data interface 108 relative to an electronic circuit having a parallel data interface without the transition control circuitry 110; and/or reduce power consumption due to bit transitions on the parallel date interface 108 relative to an electronic circuit having a parallel data interface without the transition control circuitry 110. In the example of FIG. 1, the transition control circuitry 110 includes a bit stream transformer 112 (labeled “BST”) configured to prepare output symbols for parallel data transmission operations. In one example embodiment, each output symbol is prepared from an input word and a bit transformation pattern. In some example embodiments, the transition control circuitry 110 also includes an inverse bit stream transformer 114 (labeled “IBST”) to recover input words from output symbols received via the parallel data interface lanes 116. In one example, the inverse bit stream transformer 114: receives or determines the bit transformation pattern used by the bit stream transformer 132 of the second electronic circuit 122; and uses the bit transformation pattern to perform an inverse transformation and recover input words from the received output symbols. As described herein, the transition control circuitry 110 may include other components such as circuitry to support extra parallel data interface lanes (n-k extra interface lanes in addition to k interface lanes) to transfer n-bit output symbols, a transition optimizer, a delay block, and/or other components.

In the example of FIG. 1, the first electronic circuit 102 is coupled to a second electronic circuit 122 via parallel data interface lanes 116. As shown, the second electronic circuit 122 may include a processor 124 (e.g., a baseband processor) and a parallel data interface 128 (which, in some example embodiments, is implemented to be the same as or similar to parallel data interface 108). In other example embodiments, the second electronic circuit 122 includes a FPGA, ASIC, memory, data sampler, transceiver, peripheral, ADC, DAC, AFE, and/or other circuit with a parallel data interface. As shown, the second electronic circuit 122 also includes an input bit stream source 135 coupled to the transition control circuitry 130 and configured to provide an input bit stream or related samples to the transition control circuitry 130. Without limitation to other example embodiments, the input bit stream source 135 may provide an input bit stream generated by the processor 124 to the transition control circuitry 130 for transfer to the first electronic circuit 102. The input bit stream may be generated by the processor 124, for example, in response to instructions stored in memory and executed by the processor 124 and/or in response to data received from the first electronic device 102). In different example embodiments, the input bit stream source 135 may be a serial communication interface or parallel communication interface between the processor 124 and the transition control circuitry 130.

The processor 124 may be any processing system or sub-system configured to process data transmitted to and from the AFE 106. In some example embodiments, the processor 124 is a baseband processor, FPGA, or ASIC. In different example embodiments, the partitioning between hardware and firmware for the processor 124 may vary.

The parallel data interface 128 of the second electronic circuit 122 includes hardware, firmware, and/or software configured to: prepare input data for transmission via parallel data interface lanes 116; and/or recover data from symbols received from the parallel data interface lanes 116. In the example of FIG. 1, the parallel data interface 128 is coupled to or includes transition control circuitry 130. The transition control circuitry 130 includes a bit stream transformer 132 configured to encode input words with additional bits to provide output symbols (encoded input words) to the parallel data interface lines 116. In some example embodiments, the transition control circuitry 130 also includes an inverse bit stream transformer 134 configured to decode the output symbols received from the parallel data interface lanes 116 and recover the related input words. As described herein, the transition control circuitry 130 may include other components, such as circuitry to support extra parallel data interface lanes (n-k extra interface lanes in addition to k interface lanes) to transfer n-bit output symbols, a transition optimizer, a delay block, and/or other components.

In some example embodiments, parallel data transmissions are one-way. As an example, if one-way parallel data transmissions are used, the transition control circuitry 110 may include only the bit stream transformer 112 (the inverse bit stream transformer 114 is omitted) while the transition control circuitry 130 includes only the inverse bit stream transformer 134 (the bit stream transformer 132 is omitted). In another example, the transition control circuitry 110 may include only the inverse bit stream transformer 114 (the bit stream transformer 112 is omitted) while the transition control circuitry 130 includes only the bit stream transformer 132 (the bit stream transformer 132 in omitted). In other example embodiments, parallel data transmissions are two-way with each electronic circuit including a respective bit-stream transformer and inverse bit-stream transformer as in FIG. 1

The RF sampling transceiver 104 of the first electronic circuit 102 may be used in a number of wireless applications (e.g., wireless communications or radar) to support high channel count (e.g., 8 transmitter and 8 receiver chains) and wide bandwidth (e.g., 1.2 GHz) operations. In one example, the RF sampling transceiver 104 samples an RF signal with multi-gigasample per second (Gsps) high-performance data converters. An example data converter includes a 14 bit, 4 Gsps analog-to-digital converter (ADC) and/or a 12 Gsps digital-to-analog converter (DAC). These example embodiments, where converters with higher sampling rates are used, allow the AFE 106 to avoid the need for mixers. With the parallel data interfaces 108 and 128, large amounts of data are transferred between the RF sampling integrated transceiver 104 and the processor 124 (e.g., a FPGA or ASIC). In one example embodiment, the system 100 transfers data using 16-bit, 1 Gsps I/Q samples (˜800 MHz bandwidth or BW) for 8 receiver (RX) channels and needs 256 gigabits per second (GBPS) of equivalent data interface. The system throughput is proportional to the sampling rate (BW of interest), the bits per sample (real/Imaginary), and the number of channels. In an N channel system, there will be N streams of data to be sent/received. In different example embodiments, the number of channels, the sampling rate, and/or BW may vary.

In a conventional approach, serializer/deserializer (SerDes) interfaces (e.g., JESD 204B/C) are used with the RF sampling transceiver 104 and the processor 124, but these SerDes interfaces consume significant power (e.g., a few Watts). Instead of SerDes interfaces, the described first and second electronic circuits 102 and 122 use respective transition control circuitry 110 and 130 to perform parallel data transmissions of output symbols, where the output symbols include an input word with additional bits or encoding to improve a transition performance target (e.g., reduced variance in the number of bit transitions for the output symbols and/or a reduced total number of bit transitions for the output symbols). In some example embodiments, each of the transition control circuitry 110 and/or the transition control circuitry 130 are configured to encode input words (generate output symbols) for parallel data transmissions by: obtaining k-bit input words (e.g., a 16-bit input word); and mapping each k-bit input word to a respective n-bit output symbol (e.g., a 20-bit output symbol). This process results in: n-k redundant bits (e.g., 4 redundant bits if k=16 and n=20), where each successive transmitted output symbol has a target number of transitions. Without the transition control circuitry, the transmission of uncoded k-bit words results in an average of k/2 bit transitions on the parallel data interface, and the standard deviation will be large. With transition control circuitry (e.g., the transition control circuitry 110 or 130), one option is to reduce the standard deviation of bit transitions for parallel data transmissions, where input words are encoded as output symbols to achieve a target number of transitions on the parallel data interface (e.g., the parallel data interfaces 108 or 128). Another option is to reduce the total number of bit transitions for parallel data transmissions, where input words are encoded as output symbols to achieve a minimum number of bit transitions on the parallel data interface (e.g., the parallel data interfaces 108 or 128). To perform parallel data recovery operations, the transition control circuitry 110 or 130 performs reverse operations (to reverse the encoding process) to decode the received output symbols and recover the intended input words.

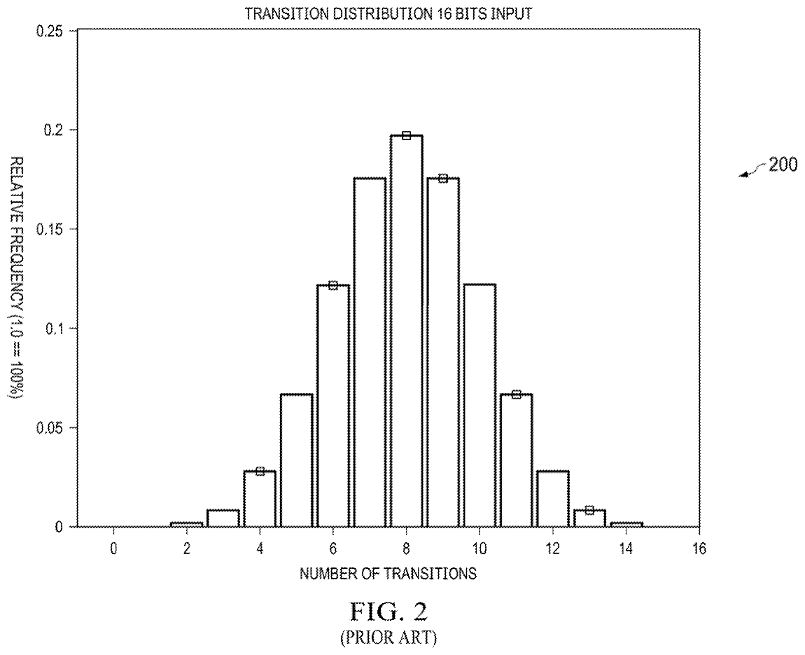

FIG. 2 is a graph 200 of bit transition distribution as a function of relative frequency for a parallel data interface in accordance with a conventional technique. For graph 200, a parallel data interface without transition control circuitry is assumed. As shown, the graph 200 shows a wide spread of bit transitions with 8 transitions as the average number of transitions. As noted herein, for a parallel data interface, a large number of bit transitions as well as a large variance (spread) in transitions is undesirable. More specifically, an increasing number of transitions increases power consumption, and an increasing variance in the number of bit transitions increases power supply ripple.

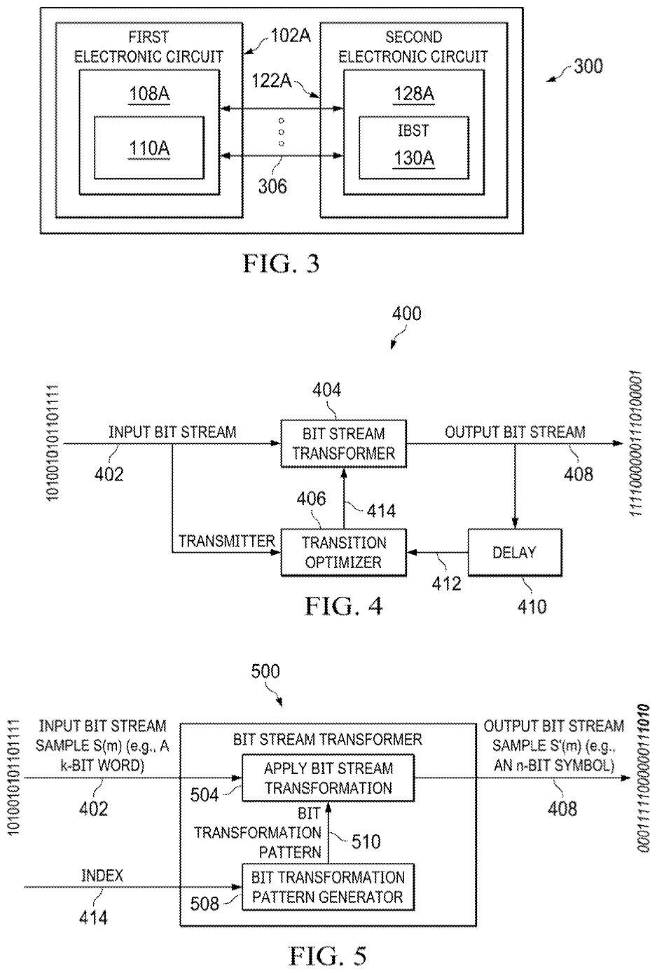

FIG. 3 is a block diagram of an IC system 300 (an example of the system 100) in accordance with an example embodiment. In FIG. 3, the IC system 300 is an MCM or IC with a first electronic circuit 102A (an example of the first electronic circuit 102 in FIG. 1) and a second electronic circuit 122A (an example of the second electronic circuit 122 in FIG. 1) in communication via parallel data interface lanes 306.

In some example embodiments, the first electronic circuit 102A includes an RF sampling transceiver (e.g., the RF sampling transceiver 104 in FIG. 1). In other example embodiments, the first electronic circuit 102A includes a baseband processor, FPGA, ASIC, a memory, a data sampler, a peripheral, AFE, ADC, DAC, and/or another circuit with a parallel data interface. As shown, the first electronic circuit 102A includes a parallel data interface 108A (an example of the parallel data interface 108 in FIG. 1) and transition control circuitry 110A (an example of the transition control circuitry 110 in FIG. 1). In some example embodiments, the second electronic circuit 122A includes a processor (e.g., the processor 124 in FIG. 1). In other example embodiments, the second electronic circuit 122A includes a FPGA, ASIC, memory, a data sampler, a peripheral, a transceiver, AFE, ADC, DAC, and/or another circuit with a parallel data interface. As shown, the second electronic device 122A includes a parallel data interface 128A (an example of the parallel data interface 128 in FIG. 1) and transition control circuitry 130A (an example of the transition control circuitry 130 in FIG. 1). Although the first and second electronic circuits 102A and 122A are represented as side-by-side, it should be understood that other arrangements are possible (e.g., a vertical arrangement with the first electronic circuit 102A above or below the second electronic circuit 122A, or separate ICs for the first and second electronic circuit 102A and 122A).

During operations of the IC system 300, increased switching activity related to the parallel data interface lanes 306 results in higher power consumption. Also, increased switching activity variance related to the parallel data interface lanes 306 results in higher power supply ripple, which may be propagated (e.g., via RF/analog coupling as multiplicative/additive spurs and noise) to the first or second circuits 102A and 122A, or other component of the IC system 300. In some example embodiments, this power supply ripple is due to the switching activity of high current CMOS switches for bit transitions (from 0 to 1, or from 1 to 0) on the parallel data interface lanes. In other words, as the switching activity varies on the parallel data interface lanes, the current draw on the power supply varies, resulting in the power supply voltage moving up and down. As the current draw due to bit transitions increases, the power supply voltage will decrease. As the current draw due to bit transitions decreases, the power supply voltage will increase. This power supply voltage variance over time results in a power supply ripple can affect different components of an electronic circuit that rely on the power supply voltage for their respective operations. Some components are sensitive to this power

has potential to limit SNR and spurious-free dynamic range (SFDR) performance of an RF sampling transceiver or other IC sub-system. With the transition control circuitry 110A and/or 130A, one option is to provide output symbols to the parallel data interface lanes 306 with encoding that reduces power supply ripple by reducing the bit transition variance for the parallel data interface lanes 306. By reducing power supply ripple, the signal bandwidth or other performance parameters of the first electronic circuit 102A can be improved. Another option available with the transition control circuitry 110A is to provide output symbols to the parallel data interface lanes 306 with encoding that reduces the total number of bit transitions and thus reduces power consumption for the first electronic circuit 102A and/or the second electronic circuit 122A.

FIG. 4 is a block diagram of a transmitter 400 with transition control circuitry in accordance with an example embodiment. In some example embodiments, the transmitter 400 is part of a parallel data interface (e.g., the parallel data interface 108 or 128 in FIG. 1). As shown, the transmitter 400 includes a bit stream transformer block 404, a transition optimizer block 406, and a delay block 410. The bit stream transformer block 404 is configured to receive input words of an input bit stream 402 (e.g., the input bit stream 402 or related samples may be provided by the input bit stream source 115 or the input bit stream source 135 in FIG. 1) over time, and to provide related output symbols of an output bit steam 408 over time. In the example of FIG. 1, the operations of the bit stream transformer block 404 are based on optimizer results 414 provided by the transition optimizer block 406.

In some example embodiments, the transition optimizer block 406 is configured to: receive an input word of the input bit stream 402 (e.g., the input bit stream 402 or related samples may be provided by the input bit stream source 115 or the input bit stream source 135 in FIG. 1); receive a delayed version 412 of a previous output symbol from the output bit stream 408 via the delay block 410; and determine the optimizer results 414 relative to a figure of merit or target criteria (e.g., a minimum variance in the number of bit transitions for output symbols resulting from application of bit transformation patterns, or a minimum number of total bit transitions for output symbols resulting from application of bit transformation patterns). The figure of merit or target criteria may be selected for a given scenario and programmed into the transition control circuitry (e.g., the transition control circuitry 110 or 130). In some example embodiments, it is possible to program the transition control circuitry more than once and/or to adjust a previous figure of merit or target criteria.

In one example, the transmitter 400 is configured to map a k-bit input word (e.g., k=16 or another integer smaller than n) to an n-bit output symbol (e.g., n=20 or another integer larger than k) to facilitate keeping the number of bit transitions on a parallel data interface constant. In some example embodiments, the transition optimizer block 406: divides a set of 2ⁿ output symbols into 2^{k} sets of 2^{n-k} candidate bit transformation patterns (i.e., 2^{n-k} candidate bit transformation patterns are associated with each one of 2^{k} input words by a bijective function mapping); compares a delayed version 412 of a previous output symbol of the output bit stream 408 with the 2^{n-k} n-bit corresponding to a current input word of the input bit stream 402; and determines the transformation index 414 (e.g., a code word) based on the comparison. In one example, k=16 and n=20. In other examples, k and n vary, where k is smaller than n. Regardless of the values for k and n, the bit stream transformer block 404 uses the transformation index 414 from the transition optimizer block 406 to obtain an output bit stream 408 with n-bit output symbols from k-bit input words of the input bit stream 402. At a receiver, a reverse mapping is used to recover the k-bit input words of the input bit stream 402 from n-bit output symbols of the output bit stream 408. In some example embodiments, the operations of FIG. 4 are performed using hardware and/or software executed by a microcontroller/processor.

FIG. 5 is a block diagram of a bit stream transformer 500 (an example of the bit stream transformers 112, 132, or 404 in FIGS. 1 and 4) in accordance with an example embodiment. In FIG. 5 and some subsequent figures, time is segmented (e.g., “m” is a given sample time, “m−1” is the previous sample time relative to m, and “m+1” is the next sample time relative to m). As shown, the bit stream transformer 500 includes a first block 504 configured to perform bit stream transformation on an input bit stream sample {S(m)} of the input bit stream 402 (each input bit stream sample is sometimes referred to herein as an input word). In some example embodiments, S(m) is a k-bit input word. Regardless of the particular length of S(m), the bit stream transformation is performed based on a bit transformation pattern 510 received from a second block 508. The second block 508 is configured to: receive the transformation index 414 of bit transformation pattern options; and select a bit transformation pattern 510 to be used with the first block 504 in accordance with a target criteria (e.g., a figure of merit or target criteria related to a bit transition target). The output of the first block 504 is an output bit stream sample {S′(m)} of the output bit stream 408 (each output bit stream sample is sometimes referred to herein as an output symbol). In some example embodiments, S′(m) is an n-bit output symbol. In the example embodiment of FIG. 5, the input bit stream is “1010010101101111” and the output bit stream is “00011111000000111010”.

In the example of FIG. 5, the index 414 is an (n-k) bit index {I(m)} provided by a transition optimizer (e.g., the transition optimizer 406 in FIG. 4) for use with generating the bit transformation pattern 510 to be used for the given sample time m. In some example embodiments, the n-k bit index information {I(m)} is embedded in the output bit stream sample S′(m), either directly (e.g., as a block of bits) or indirectly (e.g., as distributed bits). In one example embodiment, the bits of the index {I(m)} are added to either end of S(m) to generate S′(m). In another example embodiment, the bits of the index {I(m)} are distributed as separated bits throughout S(m) to generate S′(m). In some example embodiments, the operations of FIG. 5 are performed using hardware and/or software executed by a microcontroller/processor.

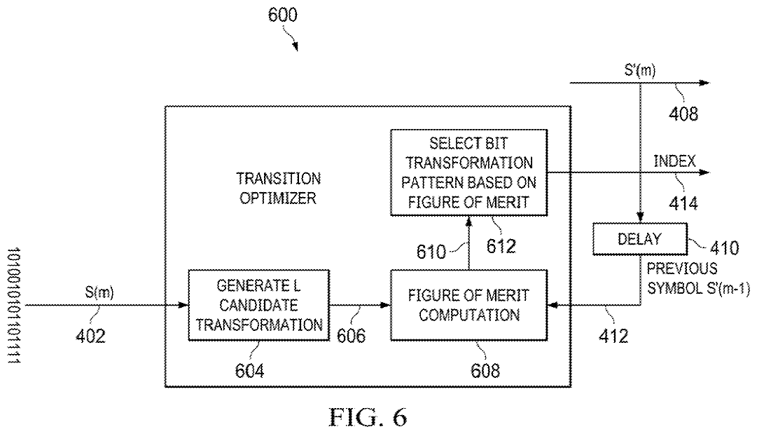

FIG. 6 is a block diagram of a transition optimizer 600 (an example of the transition optimizer block 406 in FIG. 4) in accordance with an example embodiment. As shown, the transition optimizer 600 includes a first block 604 configured to generate L candidate bit transformations 606 responsive to each input word (e.g., S(m)). The L candidate bit transformations 606 for each input word are provided to a second block 608, which is configured to perform a figure of merit computation result 610 based on the L candidate bit transformations 606 and a figure of merit or target criteria. The figure of merit result 610 is provided to a third block 612, which is configured to select a bit transformation pattern for use as the index 414 based on the figure of merit result 610. In FIG. 6, the delay block 410 receives S′(m) and provides a delayed version 412 of the previous output bit stream sample S′(m−1) to the second block 608 for use in calculating the figure of merit result 610. In some example embodiments, the operations of FIG. 6 are performed using hardware and/or software executed by a microcontroller/processor.

In some example embodiments, the transition optimizer 600 applies possible transformation patterns to each input word (e.g., S(m)) to generate L candidate n-bit output symbols (e.g., 2^{n-k}). The L candidate n-bit output symbols {Y₀(m), . . . , Y_{L-1}(m)} are compared against the previous n-bit output bit stream sample {S′(m−1)} to compute the total number of bit transitions, for each of the L choices. The optimal transformation pattern is selected based on a desired figure of merit or target criteria. In one example embodiment, the figure of merit or target criteria prioritizes the total number of bit transitions being maintained as close as possible to a constant target value G. In another embodiment, the figure of merit or target criteria prioritizes minimization of the total number of bit transitions.

In some example embodiments, the transition optimizer 600: associates each k-bit input bit stream sample (e.g., 2¹⁶ input words if k=16) with sixteen (2⁴) candidate patterns/masks; and constructs sixteen n-bit (e.g., 20 bit) output symbols for each input word. In other words, each output symbol is the result of combining an input word with a bit transformation pattern (e.g., using the pattern index {[16 bits][4 bits]}). In different example embodiments, a bit transformation pattern is combined with an input word using a direct or indirect embedding function. For example, if the input words are k-bit words and the pattern is n bits, the input words may be zero padded to construct the n-bit output symbols. As another option, a k-bit input word may be combined with a pattern (e.g., the k-bit input word is appended with a n-k bit index). In some example embodiments, for each input word, an output symbol is selected that is closest to a target number of transitions. This can be modified to any criteria (e.g., the least amount of bit transition variance, the lowest number of total bit transitions, or some other criteria). In some example embodiments, the figure of merit or target criteria: makes the relative probability of the most frequent number of transitions as close to 1 as possible; has low standard deviation; and lowers the average number of transitions.

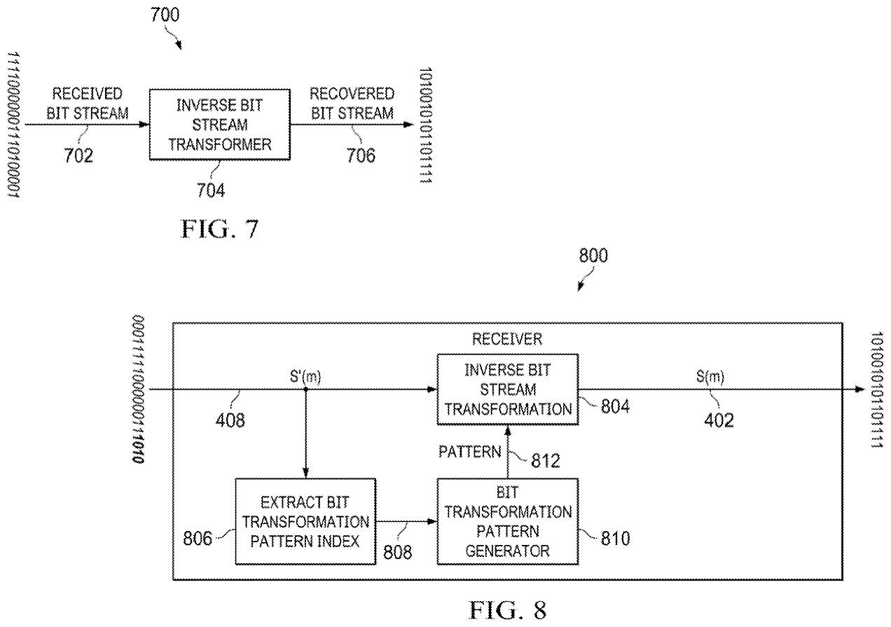

FIG. 7 is a block diagram 700 of an inverse bit stream transformer block 704 (e.g., the inverse bit stream transformer 114 or 134 in FIG. 1) in accordance with an example embodiment. In the example of FIG. 7, the inverse bit stream transformer block 704: receives the output symbols of a received bit stream 702 (e.g., the output bit stream 408 in FIGS. 4-6) via a parallel data interface; and outputs a recovered bit stream 706 (e.g., the input bit stream 402 in FIGS. 4-6). To perform the inverse bit stream transformation and recover the input words from the output symbols, the inverse bit stream transformer block 704 includes an inverse transformation algorithm, instructions, and/or related hardware to undo the transformation previously applied to the input words. In some example embodiments, the operations of FIG. 7 are performed using hardware or software executed by a microcontroller/processor.

FIG. 8 is a block diagram of a receiver 800 (an example of the receiver side of the RF sampling transceiver 104 in FIG. 1) in accordance with an example embodiment. As shown, the receiver 800 includes a first block 804 configured to: obtain the output bit stream sample S′(m) of the output bit stream 408 (e.g., an n-bit output symbol) via parallel data interface lanes; and recover S(m) of the input bit stream 402 responsive to an inverse transformation pattern 812. In the example of FIG. 8, the inverse transformation pattern 812 is obtained using a second block 806 and a third block 810. The second block 806 is configured to receive S′(m) and extract a bit transformation index {I(m)} 808 from S′(m). Note: The extracted bit transformation index may, but does not have to, vary for each output symbol depending on the target criteria. The third block 810 then generates an inverse bit transformation pattern 812 for use by the first block 804 based on the extracted bit transformation index 808. The inverse transformation pattern 812 is applied to the S′(m) by the first block 804 to undo the effect of the bit transformation performed at the transmitter and thus recover S(m). In like manner, the receiver 800 is able to obtain other output bit stream samples (e.g., S(m+1), S(m+2), etc.) of the output bit stream 408 and recover respective input words of the input bit stream 402. The operations of FIG. 8 are performed either using hardware or software executed by a microcontroller/processor.

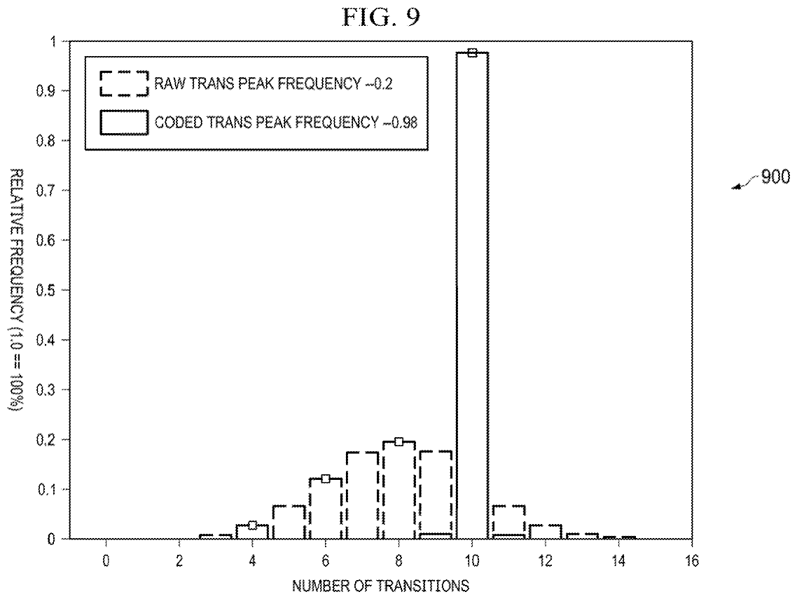

FIG. 9 is a graph 900 of bit transition distribution as a function of relative frequency comparing raw bit transitions (without encoding/transformation) for a 16-bit input word on a parallel data interface (dashed-line plots) and coded bit transitions (with encoding/transformation) for a 20-bit output symbol on a parallel data interface due to bit stream transformation operations in accordance with an example embodiment (solid-line plots). In graph 900, coded bit transitions result in 10 bit transitions 98% of the time. Also, the variance in the total number of bit transitions for coded bit transitions is approximately 0.023. By comparison, raw bit transitions result in 8 transitions 20% of the time, and the variance in the total number of bit transitions is approximately 4. The reduced variation in toggle factor (bit transition variance) provided by coded bit transitions mitigates power supply ripple and related issues relative to raw bit transitions.

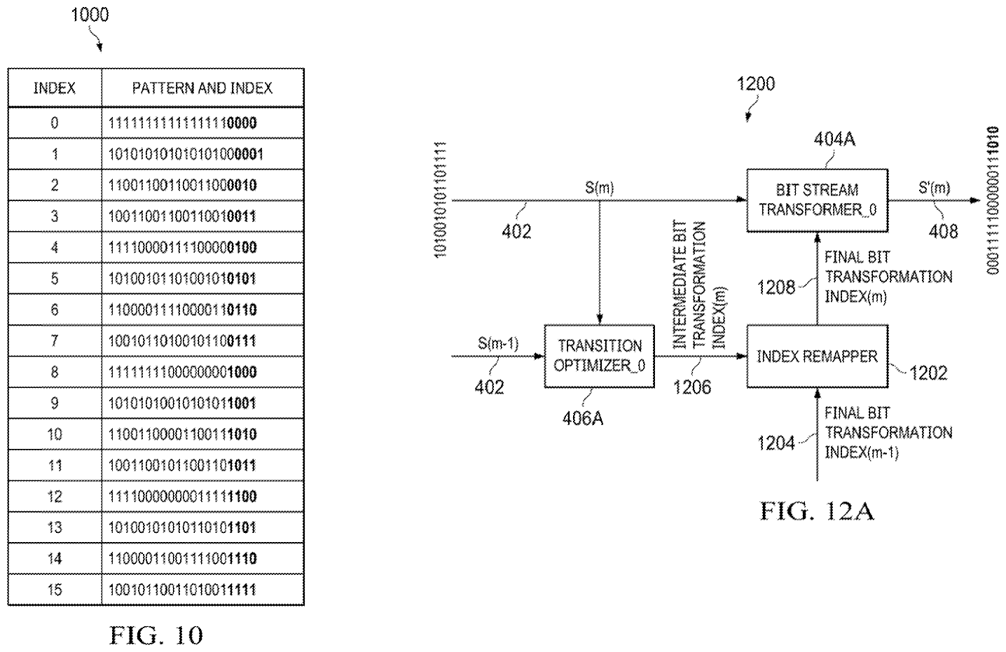

FIG. 10 is a table 1000 of bit transformation patterns in accordance with an example embodiment. Specifically, the index of table 1000 is 0-15 (a 4-bit value) due to the difference between n (the bit length of output symbols) and k (the bit length of input words) being 4. Depending on the values of k for input words and n for output symbols, the index may vary. The 16-bit patterns to which the 4-bit index values are applied in table 1000 are predetermined and may vary. In some example embodiments, bit transformation patterns are determined by computing the number of transitions between two successive output symbols (e.g., each n-bits in length). In one example embodiment, bit transformation patterns are determined by padding k-bit input words so that there are a total of n-bits, and then XORing the padded input words with n-bit masks.

In some example embodiments, transmitter-side bit stream transformation operations include: selecting candidate bit transformation patterns or static masks (e.g., the 16-bit patterns and 4-bit index patterns as shown in table 1000); analyzing the number of transitions between a previous n-bit output symbol and the output symbols resulting from use of the candidate bit transformation patterns with a given input word; selecting a bit transformation pattern (from the candidate bit transformation patterns) that best complies with a target bit transition constraint; and using the selected bit transformation pattern to generate an output symbol for the given input word. Later, the receiver-side inverse bit stream transformation operations include: determining the (n-k) bit pattern index used for transformation of a k-bit input word to an n-bit output symbol; and unmask the k-bit input word based on the pattern index.

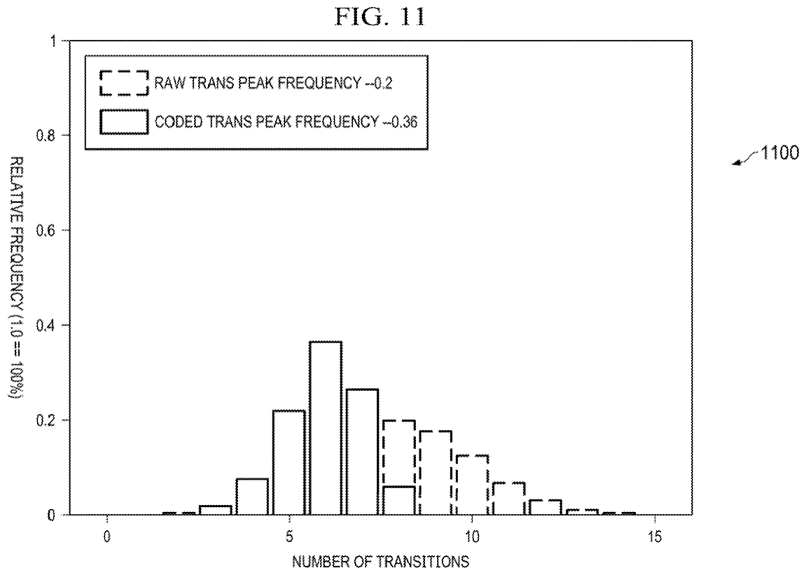

FIG. 11 is a graph 1100 of bit transition distribution as a function of relative frequency comparing raw bit transitions for a 16-bit input word on a parallel data interface (dashed-line plots) and coded bit transitions for a 20-bit output symbol on a parallel data interface (solid-line plots). The coded bit transitions are due to operations of a bit stream transformer as described herein. In some example embodiments, the coded bit transitions in the graph 1100 are the result of a bit transformation option involving a simple XOR operation of a 16-bit input word with a 16-bit transformation pattern. In this example, the transition optimizer uses a minimal total number of transitions as the figure of merit or target criteria. Among all possible transformation patterns, the one achieving the lowest number of total transitions is selected. As shown in the graph 1100, the average number of bit transitions for coded bit transitions is approximately 6 (out of 20 parallel data interface lanes). Also, the variance of bit transitions for coded transitions of the parallel data interface lanes is approximately 1.2. By comparison, the average number of transitions for raw bit transitions is 8 (out of 16 parallel data interface lanes), and the variance in the total number of bit transitions for raw bit transitions is approximately 4. The reduced variance (approximately 25%) in toggle factor (bit transition variance) provided by coded bit transitions compared to raw bit transitions mitigates power supply ripple and related issues. Also, lowering the total number of transitions by using coded bit transitions instead of raw bit transitions reduces power consumption.

In different example embodiments, the transition control circuitry (e.g., the transition control circuitry 110 and 130 in FIG. 1) and related bit stream transformation options and topologies (e.g., serial, parallel, or pipelined) may vary. Such variance may be due to the intended clock rate of a particular system, complexity considerations, speed of operations, or other considerations. In some example embodiments, the transition control circuitry 110 and 130 may use different bit stream transformation options and topologies. As an example, the transition control circuitry 110 may use a parallelization factor of 1, while the transition control circuitry 130 may use a parallelization factor of 2 with half the clock rate.

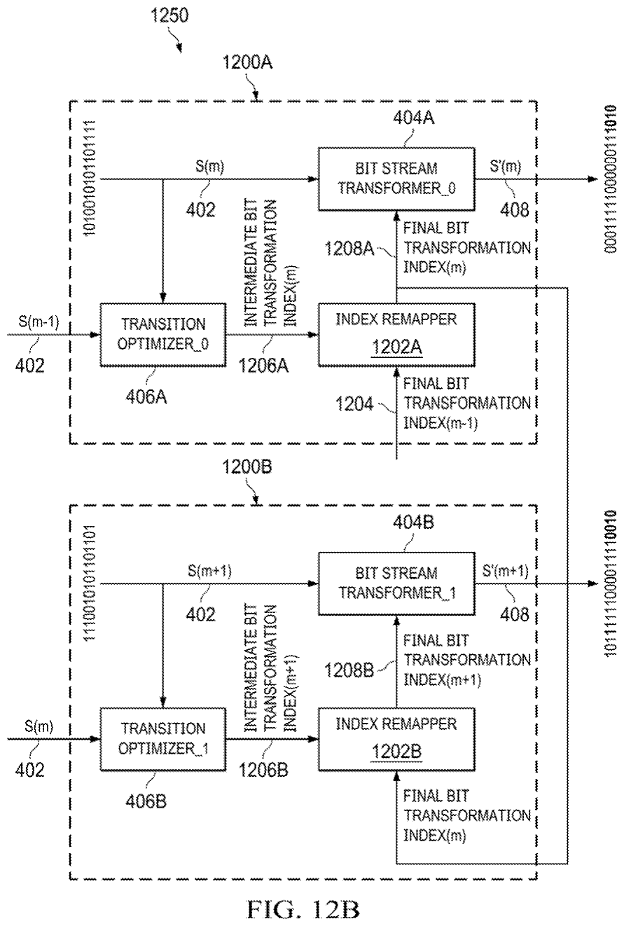

FIGS. 12A and 12B are block diagrams of parallelized implementations of transition control circuitry 1200 and 1250 in accordance with example embodiments. In FIG. 12A, the transition control circuitry 1200 includes a topology that can be parallelized as desired. As shown, the transition control circuitry 1200 includes a bit stream transformer block 404A (an example of the bit stream transformer 404 in FIG. 4), a transition optimizer block 406A (an example of the transition optimizer block 406 in FIG. 4), and an index remapper block 1202. The bit stream transformer block 404A is configured to receive S(m) of the input bit stream 402 and provide S′(m) of the output bit stream 408. The transition optimizer block 406A (an example of the transition optimizer block 406 in FIG. 4) is configured to determine an intermediate bit transformation index(m) 1206 from S(m) and S(m−1). The index remapper block 1202 is configured to determine a final bit transformation index(m) 1208 based on the intermediate bit transformation index(m) 1206 and a final bit transformation index(m−1) 1204 (the bit transformation index for time m−1). The bit stream transformer block 404A generates S′(m) based on S(m) and the final bit transformation index(m) 1208. With the index remapper block 1202, parallelization of the transition control circuitry 1200 and determination of a final transformation index for time m is facilitated by using the previous transformation index for time m−1.

In FIG. 12B, the transition control circuitry 1250 includes transition control circuit 1200A and 1200B (each an example of the transition control circuitry 1200 in FIG. 12A) to provide a topology with parallelization by 2. Specifically, the transition control circuit 1200A includes the bit stream transformer block 404A, which is configured to receive S(m) of the input bit stream 402 and provide S′(m) of the output bit stream 408. The transition optimizer block 406A uses S(m) and S(m−1) to determine an intermediate bit transformation index(m) 1206A. The transition control circuitry 1200A includes an index remapper block 1202A (an example of the index remapper 1202 in FIG. 12A) that determines a final bit transformation index(m) 1208A based on the intermediate bit transformation index(m) 1206 and the final bit transformation index(m−1) 1204. The bit stream transformer block 404A generates S′(m) based on S(m) and the final bit transformation index(m) 1208A.

The transition control circuit 1200B includes a bit stream transformer block 404B (an example of the bit stream transformer 404 in FIG. 4) configured to receive S(m+1) of the input bit stream 402 and provide S′(m+1) of the output bit stream 408. The transition optimizer block 406B (an example of the transition optimizer blocks 406 in FIG. 4) uses S(m) and S(m+1) to determine an intermediate bit transformation index(m+1) 1206B. The transition control circuitry 1200B includes an index remapper block 1202B, which determines a final bit transformation index(m+1) 1208B based on the intermediate bit transformation index(m+1) 1206B and the final bit transformation index(m) 1208A. The bit stream transformer block 404B is configured to generate S′(m+1) based on S(m+1) and the final bit transformation index(m+1) 1208B. As desired, further parallelization is possible (e.g., 4 transition control circuits 1200 in parallel, etc.).

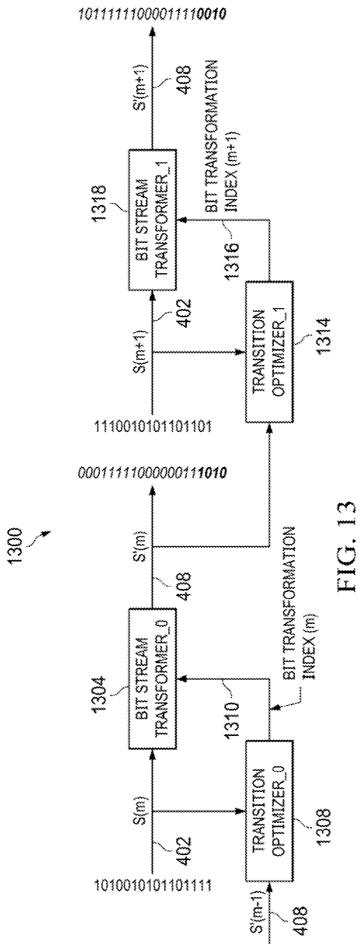

FIG. 13 is a block diagram of a serialized implementation of transition control circuitry 1300 (an example of the transition control circuitry 110 or 130 in FIG. 1, or the transition control circuitry 110A or 130A in FIG. 3) in accordance with an example embodiment. As shown, the transition control circuitry 1300 includes a first bit stream transformer block 1304 configured to receive S(m) of the input bit stream 402 and to provide S′(m) of the output bit stream 408 based on S(m) and a bit transformation index(m) 1310. In the example of FIG. 13, the bit transformation index(m) 1310 is provided by a first transition optimizer block 1308 configured to generate the bit transformation index(m) 1310 based on S(m) of the input bit stream 402 and S′(m−1) of the output bit stream 408.

As shown, S′(m) of the output bit stream 408 is provided from the first bit stream transformer block 1304 to a second transition optimizer block 1314. In the example of FIG. 13, the second transition optimizer block 1314 is configured to generate a bit transformation pattern (m+1) 1316 based on S′(m) of the output bit stream 408 and S(m+1) of the input bit stream 402. The transition control circuitry 1300 also includes a second bit stream transformer block 1318 configured to generate S′(m+1) of the output bit stream 408 based on S(m+1) and the bit transformation index(m+1) 1316. With a serial topology of FIG. 13, the transition control circuitry 1300 has reduced complexity and related benefits (smaller size, cost, etc.) compared to the parallel topologies of FIGS. 12A and 12B. In some example embodiments, the operations of FIG. 13 are performed either using hardware and/or software executed by a microcontroller/processor.

In some example embodiments, a parallel data interface can support a rate of 2 GBPS. However, such high-speed digital clocks (CLKs) may not be compatible with a given FPGA or AFE. To address this issue, a parallelized implementation (e.g., parallelized by 2 as in FIG. 12B) is used, in which bit streams corresponding to two consecutive sampling instances, m and m+1, are processed in a single clock cycle. In contrast, the transition control circuitry 1300 performs bit stream transformation for two consecutive samples as shown in FIG. 13. Note: the second transition optimizer block 1314 is configured to use S(m+1) and S′(m), which may be computed in the same clock cycle, to determine an optimal bit transformation index {I(m+1)}. Hence, this transition control circuitry 1300 is not easily amenable to a parallelized implementation.

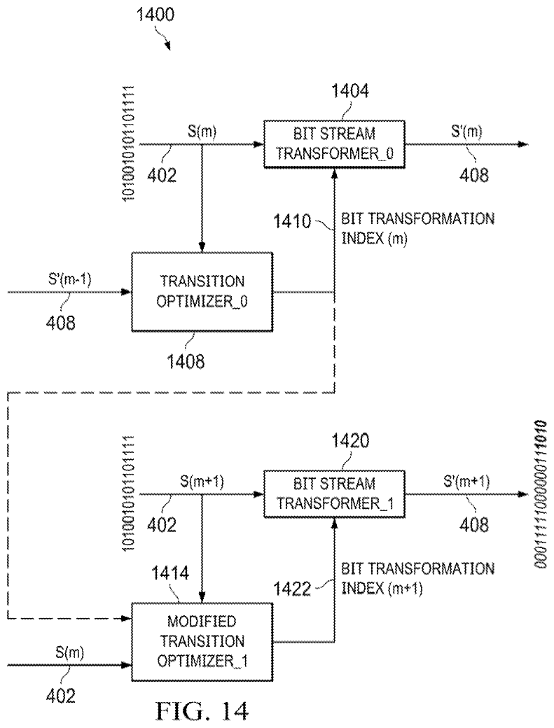

FIG. 14 is a block diagram of another parallelized implementation of transition control circuitry 1400 (an example of the transition control circuitry 110 or 130 in FIG. 1, or the transition control circuitry 110A or 130A in FIG. 3) in accordance with an example embodiment. As shown, the transition control circuitry 1400 includes a first bit stream transformer block 1404, which is configured to receive S(m) of the input bit stream 402 and to provide S′(m) of the output bit stream 408 based on S(m) and a bit transformation index(m) 1410. In the example of FIG. 14, the bit transformation index(m) 1410 is provided by a transition optimizer block 1408, which is configured to generate the bit transformation index(m) 1410 based on S(m) of the input bit stream 402 and S′(m−1) of the output bit stream 1406.

The transition control circuitry 1400 also includes a second bit stream transformer block 1420 configured to provide S′(m+1) of the output bit stream based on S(m+1) of the input bit stream 402 and a next bit transformation index(m+1) 1422. In the example of FIG. 14, the next bit transformation index(m+1) 1422 is provided by a modified transition optimizer block 1414 configured to generate a next bit transformation index(m+1) 1422 based on S(m), S(m+1), and the bit transformation pattern or index(m) 1410. In some example embodiments, the operations of FIG. 14 are performed using hardware and/or software executed by a microcontroller/processor.

With the parallelized implementation and modified transition optimizer 1414, the transition control circuitry 1400 generates S′(m) and S′(m+1) of the output bit stream 408 in 1 clock cycle. As S′(m) could be generated using any one of L possible transformation patterns, the modified transition optimizer block 1414 applies all possible transformation patterns to S(m) and S(m+1) to generate L candidate n-bit output symbols for each. In example embodiment embodiments, the L candidate output symbols {Y₀(m+1), . . . , Y_{L-1}(m+1)} are compared against the previous L candidate output symbols {Y₀(m), . . . , X_{L-1}(m)} to compute total number of bit transitions for each of L² combinations. Then L optimal transformation pattern indices for {I(m+1)}, for each possible choice of {I₀(m+1), . . . , I_{L-1}(m+1)}, are selected. Once {I(m)} is determined, an L:1 MUX selects the optimal transformation pattern index {I(m+1)}. This however results in significant increase in complexity in the modified transition optimizer block 1414.

In some example embodiments, a pipelined topology is used when the time for completion of the processing exceeds the period of sampling (1/Fs). In such cases, the processing is split between different sampling periods and the throughput (processing rate) is matched to the input rate at the expense of latency (delay). The latency is the result of splitting the processing across multiple time periods. Pipelined operations during different time periods are shown in Table 1 below.

TABLE 1
Time interval

| m | m + 1 | m + 1 | m + 1 |
|---|---|---|---|
| Transition | Transition | Transition | Transition |
| optimizer | optimizer | optimizer | optimizer |
| (m) | (m + 1) | (m + 2) | (m + 3) |
| Index remapper | Index remapper | Index remapper | Index remapper |
| (m − 1) | (m) | (m + 1) | (m + 2) |
| Bit stream | Bit stream | Bit stream | Bit stream |
| transformer | transformer | transformer | transformer |
| (m − 2) | (m − 1) | (m) | (m + 1) |

As shown in Table 1, the three operations that are pipelined include transition optimizer operations, index remapper operations; and bit stream transformer operations. Since the transition optimizer is the most complex operation, in some example embodiments, a full sample period (time instance m) is set apart for the transition optimizer to complete its operation. In the same time instance (m), the index remapper performs the operation for the previous symbol (corresponding to time instance m−1) and the bit stream transformer is performing the operations for the symbol prior to m−1 (i.e., time instance m−2). Thus, the output corresponding to a symbol at time instance m is available at time instance m+2 a latency of 2 time intervals. The hardware units for a pipeline topology is similar to the parallel by 1 topology of FIG. 12A, except the sub modules are processing samples corresponding to different time instances. As one output is available every period (except for a latency of 2 units in this example), the output throughput is matched to the input.

In some example embodiments, a transition control circuit with a pipelined or parallelized arrangement performs the following operations: 1) the transition weight computation can be performed on the raw input word; and 2) a temporary pattern index (Index) is selected which satisfies a target transition criteria. In some example embodiments, these two operations involve XOR operations and bit counting. For some operations, no input from the previous time instance is needed. Also, in some example embodiments, a pattern index (MaskIndex^{T}) is a function of Index and MaskIndex^{T-1}. In other words, a temporary index T+1 and index T is used to determine the index for T+1. The advantage of this technique is that some related complex operations (e.g., generating L candidates and selecting the best one) can be performed in parallel, and subsequent operations to determine the index T+1 from the temporary index T+1 and index T are relatively less complex. Also, the pattern index may be a bijective function. In some example embodiments, an XOR of Index and MaskIndex^{T-1} is performed.

In some example embodiments, the k-bit input word is split into (n-k) groups of bits gᵢ each (G). The grouping is done such that the sum adds to k bits i.e. Σᵢ₌₀^{n-k-1} gᵢ=k. As an example, 17 bits can be broken into 6, 6, 5 bits each. Each (n-k) groups in G is associated with a invert bit to form a padded group G′. The initial value of the invert bit is 0 (i.e., no inversion). Each group is associated with a threshold equal to

$$\frac{{g}_{i} + 1}{2} .$$

In some example embodiments, the input word is encoded as follows: 1) each of the bits in the (n-k) groups G′ are compared to the corresponding bits transmitted in the previous time instance; and 2) the number of bit transitions in each group g′ E G′ are computed. For each group in G′, if the number of bit transitions>threshold, then the group is inverted. This will make the invert bit in that particular group 1 (as it was initialized to 0)

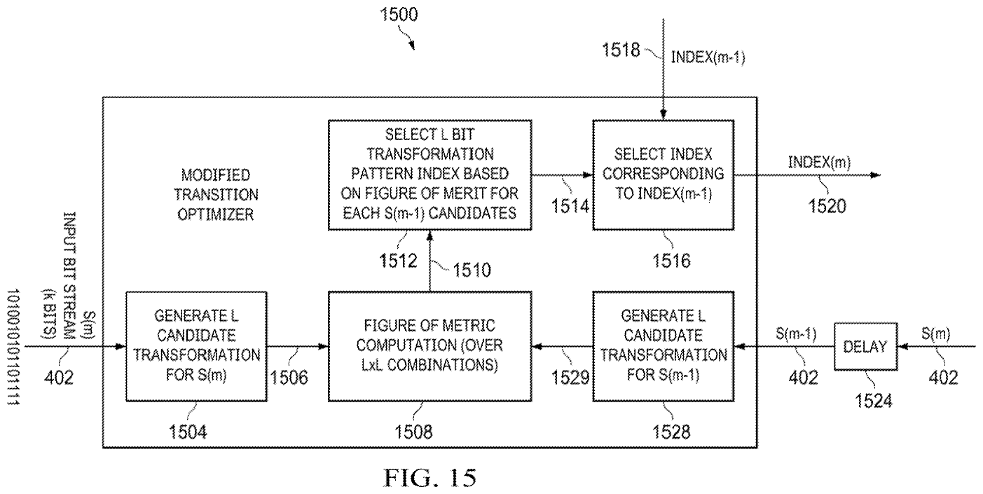

FIG. 15 is a block diagram of a modified transition optimizer 1500 (an example of the modified transition optimizer 1414 in FIG. 14) in accordance with an example embodiment. As shown, the modified transition optimizer 1500 includes a first block 1504 configured to generate L candidate transformations 1506 for S(m) of the input bit stream 402. At block 1508, a figure of merit computation is performed over L×L combinations. As shown, block 1508 also receives L candidate transformations 1529 from a block 1528, which is configured to generate the L candidate transformations 1529 from S(m−1) of the input bit stream 402. For example, S(m−1) is obtained by passing S(m) through a delay block 1524.

The output of block 1508 is a set of candidates 1510 that best comply with the figure of merit applied at block 1508. In FIG. 15, a block 1512 receives the set of candidates 1510 and selects an L bit transformation index 1514 based on the figure of merit for each of the S(m−1) candidates. At block 1516, an index (Index(m)) 1520 is selected based on index(m−1) and the L bit transformation index 1514. In some example embodiments, the operations of FIG. 15 are performed using hardware and/or software executed by a microcontroller/processor.

In some example embodiments, the modified transition optimizer 1500 constructs a set of L transformation patterns by: 1) imposing a constraint of a ‘closed set’ under the transformation operation; 2) replacing S′(m+1) with S(m+1) in the modified transition optimizer 1500 to compute an intermediate index {Iᵢₙₜ(m+1)}; and 3) employing an index remapper to compute {I(m+1)} from {Iᵢₙₜ(m+1), I(m)}. In one example embodiment, the L transformation patterns are generated with the following constraints: 1) XOR of any two patterns selected from the L patterns, is also a member of the set; 2) Patternₓ ⊕Pattern_{y}=Pattern_{z}; z=f(x,y); z ∈{0, . . . , L−1}, ∀x,y∈{0, . . . , L−1}; 3) the modified transition optimizer 1500 determines the optimal intermediate index using S(m), instead of the non-available S′(m); and 4) an increase in complexity is avoided (L instead of L² computations). With the modified transition optimizer 1500, the previous output symbol is XORed with potential outputs for the current input word. This does not allow a parallelized implementation.

In some example embodiments, a more careful selection of patterns can be performed for parallelized operations. As an example, selection of patterns to enable a parallelized implementation may involve: 1) generating 2^{L} (L=n−k) candidate patterns; 2) selecting L ‘basis patterns’ of length k; 3) denoting the candidate patterns by M₀, M₁, . . . , M_{L-1}; 4) generating 2^{L} patterns as all possible linear combinations of the L masks (e.g., Mask_{b}_{₀}_{b}_{₁} _{. . . b}_{_{L-1}}=b₀M₀⊕b₁M₁⊕ . . . ⊕b_{L-1}M_{L-1}); and 5) constructing the 20-bit pattern as [Mask_{b}_{₀}_{b}_{₁} _{. . . b}_{_{L-1}}|b₀b₁ . . . b_{L-1}] (the pattern concatenated with a binary weight). In this example, the mask set has the property that any mask XORed with another mask is a valid mask. The masks form a set which is closed under the XOR operation (i.e., the bit stream transformation operation of choice in the current example). Hence, the distribution of number of transitions between the L candidate transformations corresponding to S(m) and S′(m−1) is identical to the distribution of the number of transitions between the L candidate transformations corresponding to S(m) and S(m−1) transformed by any arbitrary mask. In the given example mask set, the transformation pattern includes the all-zero pattern, and S(m−1) transformed by any arbitrary mask is simply a zero padded version of S(m−1).

As an example, the pattern generation may be performed as follows: 1) split k into n-k groups of bits, each of width gᵢ such that Σᵢ₌₀^{n-k-1} gᵢ=k; 2) have Mᵢ=(2^{g}^{ᵢ}−1)<<Σₖ₌₀ⁱ⁻¹ gₖ; 3) Mᵢ will have a binary representation of (gᵢ 1's) followed by Σₖ₌₀ⁱ⁻¹ gₖ 0 's. For example,

if {gᵢ}={5,5,6}

M₀=‘0000000000011111’, M₁=‘0000001111100000’, M₂=‘1111110000000000’
In another example, the mask generation is performed by selecting the pattern using the following expression

$${M}_{i} = repeat [ ( \frac{k}{{2}^{i + 1}} ) {0}^{′} s , ( \frac{k}{{2}^{i + 1}} ) {1}^{′} s ] {2}^{i} times .$$

As an example, if k=16, and L=4,

M₀=‘0000000011111111’, M₁=‘0000111100001111’,

M₂=‘1100110011001100’, M₃=‘0101010101010101’

In another example, the pattern generation is performed by selecting L masks Mᵢ from a list of k length orthogonal/nearly orthogonal bit patterns. As an example, if k=17 and L=3,
M₀=‘10101010101010101’, M₁=‘10100101010110100’, M₂=‘11000011001111001’

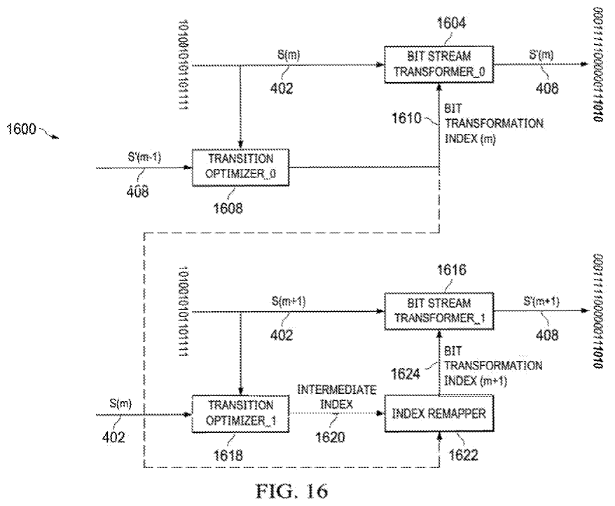

FIG. 16 is a block diagram of transition control circuitry 1600 (an example of the transition control circuitry 110 or 130 in FIG. 1, or the transition control circuitry 110A or 130A in FIG. 3) for parallel processing of more than one symbol at a time (e.g., FIG. 16 relates to an embodiment that parallel processes 2 symbols at a time) in accordance with another example embodiment. As shown, the transition control circuitry 1600 includes a first bit stream transformer block 1604 configured to receive S(m) of the input bit stream 402 and to provide S′(m) of the output bit stream 408 based on a bit transformation index(m) 1610. In the example of FIG. 16, the bit transformation index(m) 1610 is provided by a transition optimizer block 1608 configured to generate the bit transformation index(m) 1610 based on S(m) and S′(m−1).

The transition control circuitry 1600 also includes a second bit stream transformer block 1616, which is configured to receive S(m+1) of the input bit stream 402 and to provide S′(m+1) of the output bit stream 408 based on a bit transformation index(m+1) 1624. In the example of FIG. 16, providing the bit transformation index(m+1) 1624 to the second bit stream transformer block 1616 involves a transition optimizer block 1618 and an index remapper block 1622. The transition optimizer block 1618 is configured to generate an intermediate index 1620 based on S(m) and S(m+1). The index remapper block 1622 is configured to generate the bit transformation index(m+1) 1624 from the intermediate index 1620 and the bit transformation index(m) 1610. As an alternative, the upper and lower portions of the transition control circuitry 1600 may be identical to each other.

In some example embodiments, the transition control circuitry 1600 determines the set of L (2^{n-k}) transformation patterns satisfying the constraint of being a closed set under the XOR operation. The set of L (2^{n-k}) transformation patterns can be constructed as follows: 1) select n-k candidate generator patterns {Mₙ₋ₖ₋₁, . . . , M₀} of length k, that form a ‘minimal set’ under the XOR operation; 2) define a minimal set to be such that the XOR operation performed on any selected sub-set of j (1<j≤n−k) unique elements, is not an element of the set; 3) the L transformation patterns are generated as a binary weighted XOR of the generator patterns Mᵢ; 4) {Z}=(aₙ₋ₖ₋₁Mₙ₋ₖ₋₁)⊕ . . . ⊕(a₁M₁)⊕(a₀M₀)∀a₀∈{0,1}; 5) the binary weights {aₙ₋ₖ₋₁, . . . , a₀} form the n-k bit pattern index. In one example, transition control circuitry 1600 generates patterns for n=20 and k=16 as:

M₃=‘1111111100000000’, M₂=‘1111000011110000’,

M₁=‘1100110011001100’, M₀=‘1010101010101010’

In contrast to a pipelined/parallel transition control circuitry, non-pipelined transition control circuitry performs selection of the pattern index by: 1) comparing previous transmitted symbol against all candidate output symbols corresponding to Symbol^{T}; 2) the candidate output symbol closest to the target number of transitions is sent; 3) this continues for the subsequent input word; and 4) processing starts once the previous output symbol is determined.

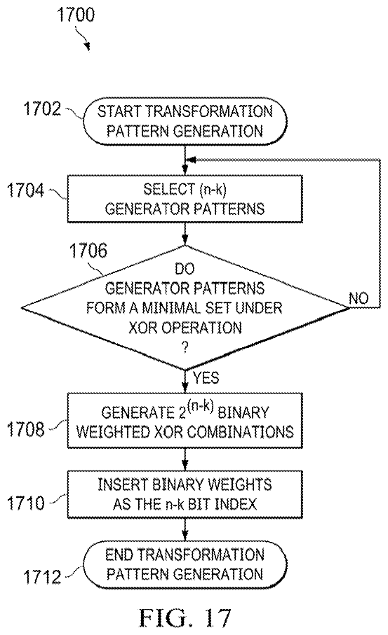

FIG. 17 is a flowchart of a transformation pattern generation method 1700 in accordance with an example embodiment. The method 1700 is performed, for example, by transition control circuitry (e.g., the transition control circuitry 110 in FIG. 1, or the transition control circuitry 110A in FIG. 3) of a first or second electronic circuit (e.g., the first or second electronic circuit 102 and 122 in FIG. 1, or the first or second electronic circuits 102A and 122A in FIG. 3). As shown, the method 1700 includes starting transformation pattern generation at block 1702. At block 1704, (n-k) generator patterns are selected. If the generator patterns do not enable compliance with the figure of merit or target criteria (by not forming a minimal set under XOR operation) (determination block 1706), the method 700 returns to block 1704. If the generator patterns enable compliance with the figure of merit or target criteria (by forming a minimal set under XOR operation) (determination block 1706), the method 700 continues to block 1708, where 2^{(n-k)} binary weighted XOR combinations are generated. At block 1710, binary weights are inserted as the n-k bit index. At block 1712, transformation pattern generation ends.

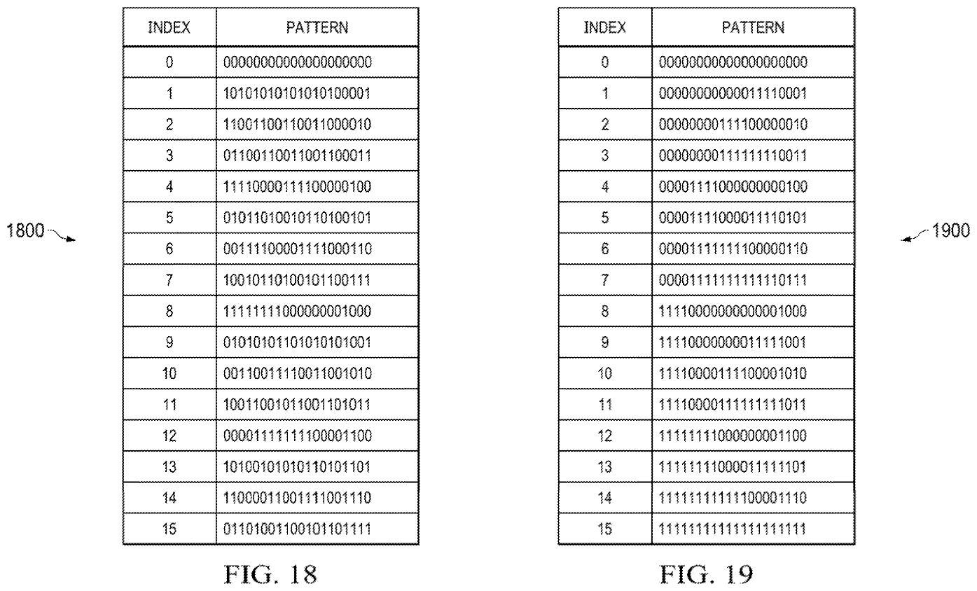

FIG. 18 is a table 1800 of transformation patterns in accordance with an example embodiment. The transformation patterns of table 1800 may be suitable for scenarios where k=16 and n=20 as described herein. Note: the transformation patterns of table 1800 are independent of the particular transition control circuit topology used.

FIG. 19 is a table of transformation patterns in accordance with yet another example embodiment. The transformation patterns of table 1900 may be suitable for scenarios where k=16 and n=20 as described herein. The transformation patterns of table 1900 are independent of the particular transition control circuit topology used. One advantage of the transformation patterns shown in table 1900 is that since the patterns are generated with generator patterns that do not have 1's at a common bit position, the transition weight can be computed hierarchically. In this case the generator patterns are:

M₃=‘1111000000000000’, M₂=‘0000111100000000’,

M₁=‘0000000011110000’, M₀=‘0000000000001111’

The number of transition can be counted as 4 sub accumulations corresponding to bits which are 1 in patterns M₀, M₁, M₂ and M₃. The 16 sums can be then obtained from these partial accumulations.

While the patterns table 1900 are suitable for condition where the 16-bit input words are independent and identically distributed, further gain in performance can be obtained in scenarios where the bits are not independent and identically distributed.

In some example embodiments, transition control circuitry (an example of the transition control circuitry 110 or 130 in FIG. 1, or the transition control circuitry 110A or 130A in FIG. 3) performs bit stream transformation from a k-bit input word to an n-bit output symbol, to optimize total number of bit transitions between successive output symbols, based on a figure of merit or target criteria. In some examples, the transition control circuitry uses a transition optimizer to determine the transformation pattern using the current input word and the previous output symbol. In one example, a figure of merit is used, where the total number of bit transitions is matched as closely as possible to a target value. In another example, a figure of merit is used, where the total number of bit transitions is minimized. In some example embodiments, the transition control circuitry employs XOR operation to perform the bit stream transformation by selecting from among L pre-stored transformation patterns. In some example embodiments, the transition control circuitry employs parallelized bit stream transformation, in which the computation of the optimal transformation pattern is decoupled by selecting the L pre-stored transformation patterns to be from a “closed set” under the XOR operation. In some example embodiments, the transition control circuitry employs an enhanced transition optimizer configured to determine an intermediate transformation pattern index by using the current and previous input word. In some example embodiments, the transition control circuitry employs an index re-mapper, that computes the current transformation pattern index from the current intermediate index and the previous transformation pattern index. In some example embodiments, the transition control circuitry constructs a set of L pre-stored transformation patterns to form a closed set under the XOR operation, by using weighted binary combinations (through XOR) of n-k generator patterns. In such case, design of the n-k “generator” patterns are selected to satisfy the minimal set property.

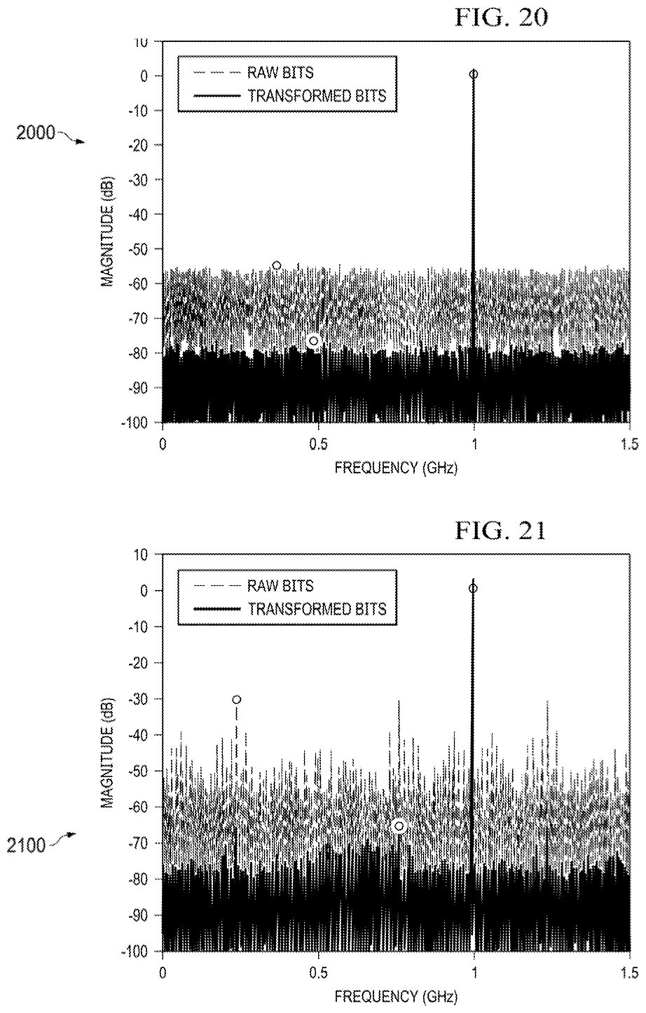

In some example embodiments, the spectral properties of the digital switching activity, due to bit transitions in the parallel data interface, for an output symbol and a raw input word can be compared. To perform the comparison, a power supply ripple is modeled at digital clock edges (1 GHz), proportional to the number of bit transitions. The bit stream transformation reduces the wide-band components by −22 dB. For single tone input, bit stream transformation achieves greater than 30 dB suppression of worst case harmonic spurs. Significant reduction in multiplicative in-band noise and signal harmonic spurs due to digital interface data switching is achieved for two different signal input as shown in graphs 2000 and 2100 of FIGS. 20 and 21.

With transition control circuitry (e.g., the transition control circuitry 110 or 130 in FIG. 1, the transition control circuitry 110A or 130A in FIG. 3, the transition control circuitry 1300 of FIG. 13, the transition control circuitry 1400 of FIG. 14, the transition control circuitry 1600 of FIG. 16, the variation in the transitions on the parallel data interface is reduced at the expense of extra lanes. Also, a tradeoff of reduced variation in transitions for lower number of transitions is possible. Also, a tradeoff of noisy interference for power is possible. The receiver implementation is simple and requires only a unmasking operation. Thus, the receiver does not need to change based on different transition selection algorithms. In some example embodiments, an additional parity bit on the interface can reduce the chances of undetected data corruption. Also, different transition control options can be developed by using different patterns or selection criteria for bit transitions at the transmitter.

In some example embodiments, a transition control interface modifies a k-bit input word to an n-bit output symbol such that the output symbol has a target number of bit transitions. In one example, modification of the input word is performed by constructing 2^{k-n} n-bit candidate output symbols for each input word (one-time operation). At the transmitter, for the input word at the current instance, the transition control circuitry selects the best output symbol from the 2^{k-n} candidate output symbols. In some example embodiments, the selection criteria for the best output symbol is a target number of bit transitions. The selected output symbol is then transmitted to the receiver. At the receiver, the k-bit input word is recovered by decoding the received n-bit output symbol.

In some example embodiments, the output symbol is given by [[input word] XOR [Mask_{index}][index]], where the index is (n-k) bits long. In some example embodiments, the 2^{k-n} masks are generated as one of the following: 1) k-bit sequences which are mutually orthogonal/close to orthogonal; or 2) 2^{k-n} linear combinations of basis vectors. The basis vectors are generated as follows: split k into n-k groups of bits, each of width gᵢ such that Σᵢ₌₀^{n-k-1} gᵢ=k; and have M₁=(2^{g}^{ᵢ}−1)<<Σₖ₌₀ⁱ⁻¹ gₖ. In this example, Mᵢ will have a binary representation of (gᵢ 1's) followed by Σₖ₌₀ⁱ⁻¹ gₖ 0 's. As an example, if {gᵢ}={5,5,6}, then M₀=‘0000000000011111’, M₁=‘0000001111100000’, M₂=‘1111110000000000’. In some examples, Mᵢ basis masks are generated with the following expression

$${M}_{i} = repeat [ ( \frac{k}{{2}^{i + 1}} ) {0}^{′} s , ( \frac{k}{{2}^{i + 1}} ) {1}^{′} s ] {2}^{i} times .$$

As an example, if k=16, and L=4, then M₀=‘0000000011111111’, M₁=‘0000111100001111’, M₂=‘1100110011001100’, M₃=‘0101010101010101’. In some examples, L masks Mᵢ are selected from a list of k length orthogonal/nearly orthogonal bit patterns. As an example, if k=17 and L=3, then M₀=‘10101010101010101’, M₁=‘10100101010110100’ M₂=‘11000011001111001’.

In some example embodiments, the transition control circuitry implements sequential processing or pipelined/parallel processing. For sequential processing, the selection of an output symbol uses a pattern/mask index based on a transition weight computation that compares the previous transmitted output symbol against all candidate output symbols corresponding to Symbol^{T}; and selects of the candidate symbol closest to the target number of bit transitions. For pipelined/parallel processing, selection of an output symbol uses the mask index based on a transition weight computation that: compares the current input word and previous input word using an XOR operation and computing the number of bit transitions; and selects a temporary mask index (Index), where the temporary mask index satisfies a target bit transition criteria; and obtains the mask index for the current time instance by applying a transformation function on the temporary mask index with the mask index selected in the previous time instance. One such transformation function is an XOR (Index,MaskIndex^{T-1}).

In some example embodiments, transition control circuitry maps a k-bit input word to an n-bit output symbol by: dividing k bits into n-k groups of bits gᵢ each such that Σᵢ₌₀^{n-k-1} gᵢ=k; and forming a new group G′ by associating each of the n-k groups with an invert bit, where the initial value of the invert bit is 0 (i.e., no inversion). In this example, a threshold of

$$\frac{{g}_{i} + 1}{2} .$$

may be used. At the transmitter, each of the bits in the (n-k) groups G′ are compared to the corresponding bits transmitted in the previous time instance. For each of the n-k groups, if the number of bit transitions is greater than the threshold, the particular group is inverted. This will make the invert bit in that particular group 1 (as it was initialized to 0). At the receiver, the invert bit for each of the (n-k) group is observed. The corresponding group of bits is inverted if the invert bit is 1. Otherwise, the bits are passed without inversion if the invert bit is 0.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof. A circuit or device that is described herein as including certain components may instead be adapted to be coupled to those components to form the described circuitry or device.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or function that is described herein as including certain components or functions may instead be adapted to be coupled to those components or functional blocks to form the described circuitry or functionality. While certain components or functional blocks may be described herein as being implemented in an integrated circuit or on a single semiconductor substrate (or, conversely, in multiple integrated circuits or on multiple semiconductor substrates), such implementation may be accomplished using more or less integrated circuits or more or less semiconductor substrates. The circuits/functional blocks of the example embodiments may be packaged in one or more device packages.

Modifications are possible in the described embodiments, and other embodiments are possible, within the scope of the claims.

What is claimed is:

1. A circuit, comprising:
a parallel data interface; and
transition control circuitry coupled to the parallel data interface, the transition control circuitry is configured to:
receive an input bit stream sample;
determine a bit transformation pattern for the input bit stream sample in accordance with a target criteria; and
generate an output bit stream symbol from the input bit stream sample and the bit transformation pattern, wherein the output bit stream symbol has more bits than the input bit stream sample.

2. The circuit of claim 1, wherein the parallel data interface includes parallel data interface lanes configured to transmit bits of the output bit stream symbol in parallel, and the target criteria minimizes bit transitions on the parallel data interface lanes.

3. The circuit of claim 1, wherein the parallel data interface includes parallel data interface lanes configured to transmit bits of the output bit stream symbol in parallel, and the target criteria minimizes variance in a number of bit transitions on the parallel data interface lanes.

4. The circuit of claim 1, wherein the transition control circuitry has a parallelized topology configured to generate multiple output bit stream symbols at a time.

5. The circuit of claim 1, wherein the transition control circuitry has a serialized topology configured generate multiple output bit stream symbols within a clock cycle.

6. The circuit of claim 1, wherein the transition control circuitry has a pipelined topology with a transition optimizer, and index remapper, and a bit stream transformer, and the transition control circuitry is configured to perform transition optimizer operations, index remapper operations, and bit stream transformer operations in different clock cycles to generate the output bit stream symbol.

7. The circuit of claim 1, wherein the transition control circuitry includes an index remapper configured to generate the bit transformation pattern based on a previous bit transformation pattern.

8. The circuit of claim 1, wherein the transition control circuit is configured to: generate a plurality of candidate bit transformation patterns; and select one of the candidate bit transformation patterns based on the target criteria.

9. The circuit of claim 1, wherein the parallel data interface and the transition control circuit are components of an integrated circuit that includes an analog-to-digital converter (ADC) or digital-to-analog converter (DAC) adapted to be coupled to another circuit via the parallel data interface.

10. The circuit of claim 1, wherein the parallel data interface and the transition control circuit are components of an integrated circuit that includes a baseband processor adapted to be coupled to another circuit via the parallel data interface.

11. A system, comprising:
a first electronic circuit; and
parallel data interface lanes coupled to the first electronic circuit and adapted to be coupled to a second electronic circuit, wherein the first electronic circuit is configured to:
receive an input bit stream sample;
determine a bit transformation pattern for the input bit stream sample in accordance with a target criteria;
generate an output bit stream symbol from the input bit stream sample and the bit transformation pattern, wherein the output bit stream symbol has more bits than the input bit stream sample; and
provide the output bit stream symbol to the parallel data interface lanes.

12. The system of claim 11, wherein the first electronic circuit includes an analog front-end (AFE) and the second electronic circuit includes a baseband processor.

13. The system of claim 11, wherein the first and second electronic circuits are on different integrated circuits.

14. The system of claim 11, wherein the first and second electronic circuits are on different chiplets of an integrated circuit.

15. The system of claim 11, wherein the parallel data interface lanes are configured to transmit bits of the output bit stream symbol in parallel, and the target criteria minimizes bit transitions on the parallel data interface lanes.

16. The system of claim 11, wherein the parallel data interface lanes are configured to transmit bits of the output bit stream symbol in parallel, and the target criteria minimizes variance in a number of bit transitions on the parallel data interface lanes.

17. The system of claim 11, wherein the transition control circuitry has a parallelized topology configured to generate multiple output bit stream symbols at a time.

18. The system of claim 11, wherein the transition control circuitry has a serialized topology configured generate multiple output bit stream symbols within a clock cycle.

19. The system of claim 11, wherein the transition control circuitry has a pipelined topology with a transition optimizer, and index remapper, and a bit stream transformer, and the transition control circuitry is configured to perform transition optimizer operations, index remapper operations, and bit stream transformer operations in different clock cycles to generate the output bit stream symbol.

20. A method, comprising:
receive an input bit stream sample;
determine a bit transformation pattern for the input bit stream sample in accordance with a target criteria;
generate an output bit stream symbol from the input bit stream sample and the bit transformation pattern, wherein the output bit stream symbol has more bits than the input bit stream sample; and
provide the output bit stream symbol to parallel data interface lanes.

21. The method of claim 20, wherein the target criteria minimizes bit transitions on the parallel data interface lanes.

22. The method of claim 20, the target criteria minimizes variance in a number of bit transitions on the parallel data interface lanes.
